(19) United States
(12) Patent Application Publication
(10) Pub. No.: US 2023/0068008 A1
(43) Pub. Date: Mar. 2, 2023

(54) Systems for Providing Access To and Utilization of Transaction Card Information Via System-Level Settings Tiles and Methods of Use Thereof

(71) Applicant: Capital One Services, LLC, McLean, VA (US)

(72) Inventors: Madeline Beyl, McLean, VA (US); Casey Barrett, McLean, VA (US); Matthew Adler, McLean, VA (US)

(21) Appl. No.: 17/461,454

(22) Filed: Aug. 30, 2021

(51) Int. Cl. G06Q 20/40; G06Q 20/38; G06Q 20/34

(52) U.S. Cl. CPC G06Q 20/401; G06Q 20/389; G06Q 20/353

(57) ABSTRACT

Systems and methods involving provision of access to and use of transaction card information via system level settings are disclosed. In one embodiment, an exemplary method may comprise enabling a user to access, from a foreground app, one or more system-level GUI elements operable to retrieve card information from within a system-level settings tile of a user computing device, receiving a user request to access the system-level settings tile while the foreground app is still visible/active on the device's screen, providing the settings tile with GUI elements by which the user identifies a card to retrieve and use for a transaction, copying or retrieving the card information pertaining to the user-selected card, and generating one or more app-level GUI elements of the foreground app with the card information to enable an execution of an activity using the desired card within the foreground app.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC., All Rights Reserved.

### FIELD OF TECHNOLOGY

The present disclosure generally relates to improved computing components and devices, improved computer-based platforms or systems, and improved computing methods configured for one or more novel technological applications involving accessing transaction card information via systems-level settings of a user computing device.

### BACKGROUND OF TECHNOLOGY

A computer network platform/system may include a computing device such as a mobile computing device, a group of computers (e.g., clients, servers, computing clusters, etc.) and other computing hardware components that are linked and communicate via software architecture, communication applications, or software applications associated with computing/mobile devices, electronic transactions, data processing, and account management or payment functionality.

### OVERVIEW OF DESCRIBED SUBJECT MATTER

In some embodiments, the present disclosure provides various exemplary technically improved method for facilitating access and utilization of transaction card information via improved display and GUI features and functionality of a user device, comprising operations such as:
enabling, by a computing device, a user to access one or more system-level graphical user interface elements within a system-level settings tile of the computing device from a foreground app (application), wherein the one or more graphical user interface elements are operable to retrieve card information pertaining to one or more cards of the user;
receiving, by the computer device, from the user, a request to access the system-level settings tile while the foreground app is visible on a screen of the computing device;
providing, by the computing device, the system-level settings tile comprising the one or more system-level graphical user interface elements to allow the user to identify the one or more cards of the user for which the card information is to be retrieved;
receiving, by the computing device, from the user, a selection of one or more of the system-level graphical user interface elements identifying a desired card from the one or more cards;
in response to the selection from the user, retrieving or copying, by the computing device, the card information pertaining to the desired card; and
generating, by the computing device, one or more app-level graphical user interface elements of the foreground app with the card information to enable an execution of an activity using the desired card within the foreground app.

In some embodiments, the present disclosure also provides exemplary technically improved computer-based systems, computer-implemented methods, and computer-readable media, including media implemented with or involving one or more software applications, whether resident on computer devices or platforms, provided for download via a server and/or executed in connection with at least one network such as via a web browser application, that include or involves features, functionality, computing components and/or steps consistent with those set forth herein.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of an exemplary system and/or platform illustrating computing components and aspects associated with mobile devices and system-level settings functionality to access transaction card information, in accordance with certain embodiments of the present disclosure.

FIG. 2 is a diagram of certain illustrative aspects of an exemplary mobile device showing GUI and system-level user interface features, in accordance with certain embodiments of the present disclosure.

FIG. 3 is a diagram showing illustrative representation and/or importation of transaction card and similar information into a settings tile of a mobile device, in accordance with certain embodiments of the present disclosure.

FIG. 4 is a flowchart illustrating an exemplary process related to providing, at a user device, access and use of transaction card information via system level settings, in accordance with certain embodiments of the present disclosure.

FIG. 5 is a block diagram depicting an exemplary computer-based system and/or platform, in accordance with certain embodiments of the present disclosure.

FIG. 6 is a block diagram depicting another exemplary computer-based system and/or platform, in accordance with certain embodiments of the present disclosure.

FIGS. 7 and 8 are diagrams illustrating two exemplary implementations of cloud computing architecture/aspects with respect to which the disclosed technology may be specifically configured to operate, in accordance with certain embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

As explained in more detail, below, various systems and methods involving provision of access to and utilization of transaction card information via system level settings are disclosed herein. In one embodiment, for example, an illustrative method may comprise enabling a user to access, from a foreground app, one or more system-level user GUI elements operable to retrieve card information from within a system-level settings tile of a user computing device such as a mobile device 160, receiving a user request to access the system-level settings tile while the foreground app is still visible/active on the device's screen, providing the settings tile with GUI elements by which the user identifies a card to retrieve and use for a transaction, copying or retrieving the card information pertaining to the user-selected card, and generating one or more app-level GUI elements of the foreground app with the card information to enable an execution of an activity using the desired card within the foreground app.

According to some embodiments, the innovations herein may be implemented in connection with a financial service entity that provides, maintains, manages, or otherwise offers financial services. Such financial service entity may be a bank, credit card issuer, or any other type of financial service entity that generates, provides, manages, and/or maintains financial service accounts that entail providing a transaction card for one or more customers, the transaction card being used at a POS device in regard to such financial services. Financial service accounts may include, for example, credit card accounts, bank accounts such as checking or savings accounts, reward or loyalty program accounts, debit account, or any other type of financial service account known to those skilled in the art.

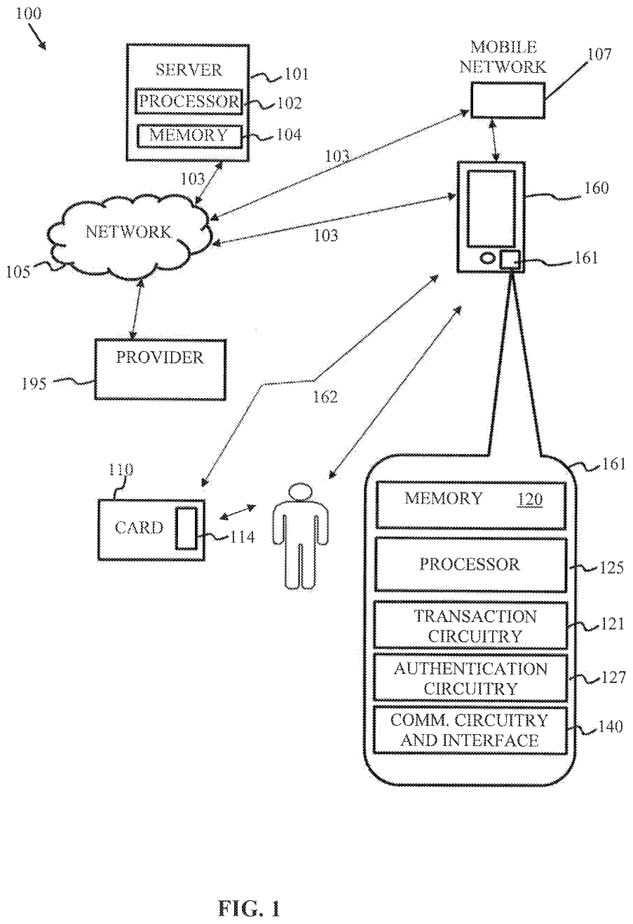

FIG. 1 is a block diagram of an exemplary system and/or platform illustrating computing components and aspects associated with utilizing system-level settings functionality to access and process transaction card information, consistent with exemplary aspects of certain embodiments of the present disclosure. In addition to one or more transaction cards 110, system 100 may include a server 101, a mobile device 160 having various processing components 161 including computer readable media and/or software applications disposed therein, and various providers 195 of goods or services, which may all communicate 103 over a communication network 105. In various illustrative embodiments represented via FIG. 1, a user may conduct transactions via a computing device such as mobile device 160, e.g., via a mobile network 107 and/or other communication applications. To complete such transactions, the user typically provides transaction card information to a merchant via a payment portal of an application, e.g., a payment portal implemented by the mobile device 160 and associated with a financial institution, such as a bank which requires card information of the user in order to electronically process the transaction. As set forth in more detail, below, implementations herein involve utilization of system-level settings associated with user computing devices, such as mobile device 160 and/or the processing components 161 associated therewith, to provide improved technological mechanisms for a user to innovatively utilize a payment option, such as a transaction card, without navigating away from an ongoing payment portal of a current process (app, browser window, etc.) that's being executed on a device, such as a user device.

In some embodiments, one or more servers 101 may be associated with one or more entities that are stakeholders to the attempted transaction, e.g., associated with the business or merchant, with one or more financial services providers, such as a bank, issuer of a credit card, debit card, or other transaction card associated with the attempted transaction.

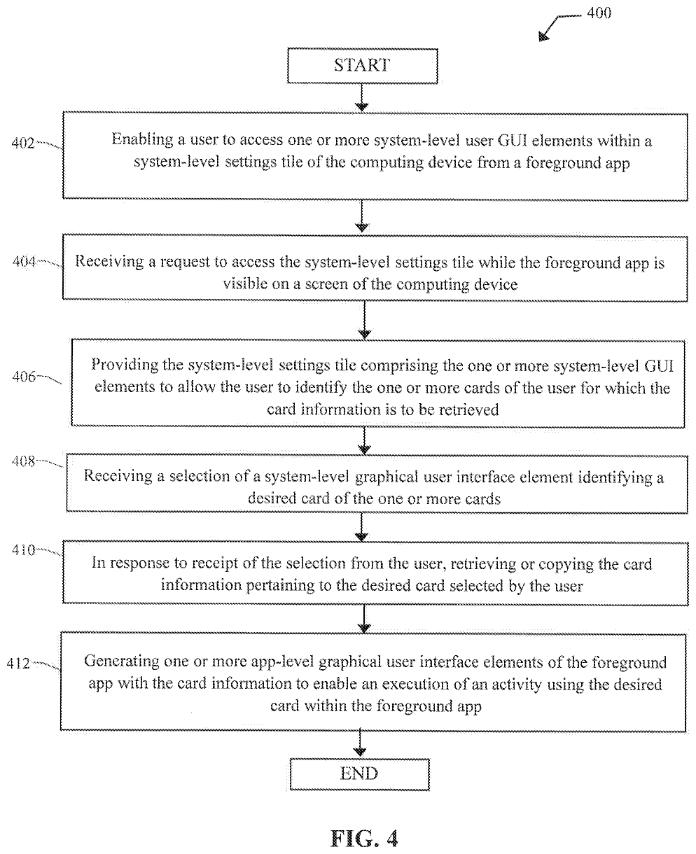

With regard to certain mobile device embodiments of the disclosed technology, the mobile device 160 and/or processing components 161, including associated computer readable media and/or software applications, may be configured to execute instructions associated with performing methods such as that described below in more detail in connection with FIG. 4. In certain embodiments that involve use of system level settings to access transaction card information, for example, the mobile device 160 and/or the processing components 161, may be configured for: receiving a request to access the system-level settings tile while the foreground app stays visible/active on the computing device, providing the system-level settings tile comprising the one or more system-level graphical user interface elements to allow the user to identify the one or more cards of the user for which the card information is to be retrieved, receiving, from the user, a selection of one or more of the system-level graphical user interface elements identifying a desired card from the one or more cards, in response to the selection from the user, retrieving or copying, the card information pertaining to the desired card, and generating, one or more app-level graphical user interface elements of the foreground app with the card information to enable an execution of an activity using the desired card within the foreground app.

It is noted that the disclosed mobile devices, systems, platforms, methods, and/or computer-readable media may perform processing associated with system settings-based access to transaction card information including and/or involving a mobile device 160 configured to perform various automated functionality set forth herein. Unlike existing solutions using conventional mobile devices, the present innovations may utilize an improved mobile device 160 that may, via provision of specialized provision and/or programming of such system-level settings tiles, be configured to allow the user to identify, access and transfer transaction card information from the system level setting tile to an app executing in the foreground, without navigation away from the foreground app. In these and other ways, implementations involving the present mobile devices 160 and associated features and system level setting-based functionality for and access to transaction card information mechanisms represent improvements over existing electronic payments using transaction card information, such as simplistic auto-fill protocols.

The disclosed implementations involving access, via system-level settings, to transaction card information also improves utilization of both processing and communication resources. As an initial matter, the present embodiments may store the transaction card information at the mobile device and allow access to the card information at a system level setting, from a concurrently executing app at the mobile device. This obviates computational operations to exit the app or navigate away from the app, and/or execute additional apps, to navigate to and/or locate a storage for the card information. Such benefits are achieved by embodiments that include providing GUI elements at a system level setting, which are activated upon a device-level action to provide selections enabling, inter alia: display of transaction card information available to the user, selection of a desired transaction card, and either copy-and-paste the selected card information to a clipboard or port the selected card information into the app. Further, because present embodiments need only perform a straightforward transfer or import from the system level settings, without involving any additional operations or apps, the processing and compute resources required are reduced substantially compared to existing techniques for electronic payments at mobile devices, including auto-fill techniques which entail various computational and related technical usage restrictions. Moreover, improved mobile devices and applications having the disclosed card information transfer mechanisms operate in an improved manner over simple auto-fill technologies and may even operate, in a settings tile, in conjunction with other (e.g., existing auto-fill) solutions, and thereby improve one or more of responsiveness, efficiency, accuracy, robustness, and/or security of device electronic payments. Implementations herein also reduce likelihood of user exposure to fraud involving cards and/or mobile devices, as well as likelihood of “lag time” associated with other techniques, thereby reducing or eliminating the need for communicating with remote entities or accessing other apps at the moment of the transaction.

Referring again to FIG. 1, server 101 may include at least one processor 102 and a memory 104, such as random-access memory (RAM). In some embodiments, server 101 may be operated by financial institutions involved with issuing and/or processing the transaction cards, by the merchant, and/or by any transaction clearing house used for authorizing the transaction card information for use, e.g., in a purchase.

Mobile device 160, such as a smart phone or other mobile, portable or wearable electronic device, includes processing components 161 such as mobile device circuitry, computer readable media and/or software applications executed and/or disposed therein. Processing components 161 may include a mobile device processor 125, memory 120, such as RAM, circuitry such as transaction circuitry 121 utilized for transactions and/or authentication circuitry utilized for authentication, communication circuitry and interfaces 140, various input and/or output devices, such as a touchscreen display, computer readable media, firmware and/or software applications. In some embodiments, memory 120 may store code that, when executed by the processor(s) 125, may cause the processor(s) to implement one or more steps associated with technology disclosed herein, including those associated with FIG. 4 and/or those involving pairing with transaction card 110 in connection with importing card information for utilization via the settings tile features set forth herein, among others. In some embodiments, any transaction card application running on mobile device 160, such as an application supplied by the financial institution issuing the transaction card and/or managing the transactions of the transaction card user, may include various modules that may process or relay information back to the financial institution (e.g., server 101), and communicate with other computing components.

Embodiments associated with the figures and associated written disclosure herein solve numerous technical problems, such as technical problems associated with allowing secure access to and transfer of information of a transaction card via a client computing device such as a mobile device, without navigation away from a primary transaction process, as well as other technical problems and drawbacks associated with existing techniques/solutions. Further, various features and functionality disclosed herein may be utilized in connection with system level settings-based access to card information processing and processes that involve pairing of transaction card 110 with mobile device 160 in beneficial ways, e.g., for importing card information, implementing multi-factor authentication (MFA) schemes, other authorization of card information for use by the user or in a transaction, and the like. In other embodiments, various information related to the successful pairing of the transaction card and the mobile device may be relayed back to server 101 (e.g., server processor 102) so as to approve transactions for purchasing goods and/or services based on authorized transaction card information.

In some embodiments, an initial authentication for pairing the transaction card with the mobile device may be implemented via the user contacting the financial institution from the user's mobile device to initially authorize the pairing of the mobile device 160 and the transaction card 110 (e.g., by circuitry 114 thereon) so as to obtain pairing authorization. In other embodiments, the pairing and/or unpair processes between the transaction card 110 and the mobile device 160 may occur automatically and seamlessly such as without any action on the part of the user, particularly if the same mobile device had been previously paired with the same transaction card in the past. In still other embodiments, various proximity MFA functionality may be utilized to pair, including techniques such as biometrics (e.g., fingerprint, voice recognition, etc.) and/or a password entered by the user and/or a swiping of the mobile device screen by a finger of the user and/or the proximity of the transaction card to the mobile device or any client device, for example, to pair or unpair the transaction card with the client.

In some embodiments, the transaction card 110 and the mobile device may be configured to pair with the transaction card on the fly when the transaction card is used during a transaction, so as to conserve computing resources, such as use of any power stored in the transaction card 110.

Referring to the diagram of FIG. 1, transaction card 110 may comprise various card components and/or circuitry 114, such as those utilized for and/or involved with communications between the card and devices, such as the mobile device 160, including pairing the transaction card 110 with the mobile device. In some embodiments, such card components and/or circuitry 114 may be used in providing or populating transaction card information of the traction card 110 in an automated manner, e.g. by pairing or otherwise, for use by the mobile device 160 during transactions, as set forth elsewhere herein.

Further, according to certain embodiments herein including the exemplary implementation of FIG. 1, the mobile device 160 may include processing components 161, such as mobile device circuitry, computer readable media and/or software applications executed and/or disposed therein, that, among other things, may be configured to: (i) provide the applications and operating environment and associated system-level settings and tiles of the disclosed technology, and (ii) pair and/or otherwise communicating with the transaction cards 110 and other computing components of the system. According to the illustrative embodiment of FIG. 1, processing components 161 may include components such as one or more of memory 120, at least one processor 125, transaction circuitry 121, authentication circuitry 127, and communication circuitry and interface(s) 140. Memory 120 may store code, such as code utilized for implementing transaction card information via settings tiles herein, and otherwise used by components of the mobile device 160 such as the transaction circuitry and the authentication circuitry 127, which when executed by processor 125 may cause processor 125 to implement providing access to and use of transaction card information via system level settings and/or other, related schemes herein (such as pairing with mobile device 160, etc.), e.g., those executed in connection with the card-based transactions of the disclosed technology.

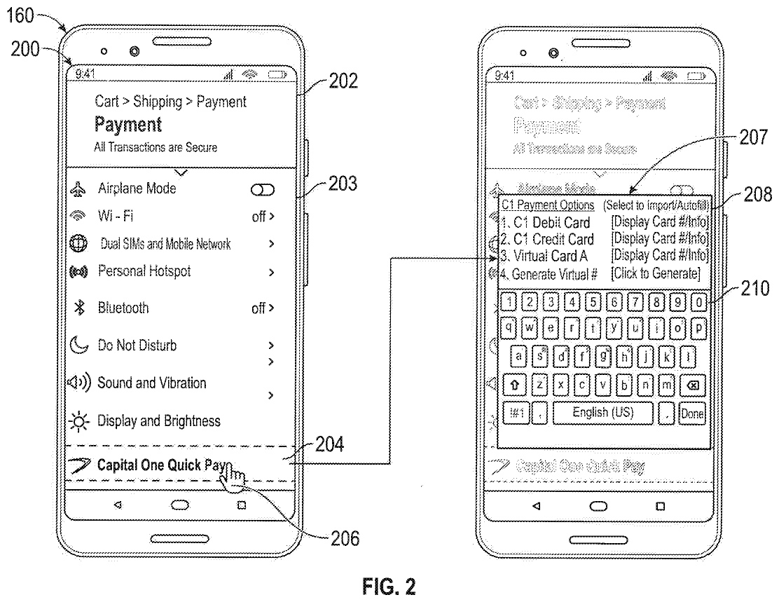

FIG. 2 is a diagram of certain illustrative aspects of an exemplary mobile device 160 showing GUI and system-level user interface features, consistent with exemplary aspects of certain embodiments of the present disclosure. FIG. 2 illustrates a diagram showing an exemplary display 200 of a mobile device 160, including a primary field 202 which may display a currently-executing foreground process, such as an application or browser page of primary interest to a user, and a secondary field or “settings tile” 203 which may display a group of settings tiles of the mobile device 160 (e.g., Android, iOS/iPhone, etc. device). In various embodiments, the secondary field 203 may be a system-level display in the sense that it can be activated at any point of time, regardless of which app is running in the foreground. Such secondary field 203 may be activated, shown or displayed via a device-level operation by the user. Here, for example, a user of the mobile device 160 may swipe up or down at the screen of the mobile device, or slide left or right, or take some other such action via the screen or other button/actuator of the mobile device to activate the system level settings tiles. In some embodiments, such activation operation may be system-configured, it may be defined by the user, or it may be set via other known means. As such, the user may activate functionality via the display 200 without interrupting the execution of a foreground application that is concurrently running on the mobile device. To navigate away from the secondary field 203 back to the foreground app once the various actions herein are completed, the mobile device 160 may be configured to do so automatically (e.g., after a desired selection or data is entered, etc.), or the user may perform a settings deactivate operation, e.g., via the screen of the mobile device (e.g., swipe up, down, leftward, rightward, in an opposite direction of the activation operation utilized), or by other button or operation of the mobile device, 160, to return to the foreground process.

As shown herein, the display 200 includes, as backdrop, a primary field 202 that displays the concurrently running foreground app executing on the mobile device. In some embodiments, the secondary field or settings tile 203 may be overlaid or superposed above such primary field 202 and associated foreground app to display a group of settings tiles, each of which corresponds to a command or operation (e.g., airplane mode, Wi-Fi mode, Bluetooth mode, etc.) that the user can perform at a system level. As shown in this example, a “Capital One Quick Pay” tile 204 may be provided and displayed via the settings tile 203 for user interactions. Upon the user's selection, at 206, of the settings tile 204, a float window 207 is displayed at a top level of the display 200 to provide the user with one or more system level graphical user interface elements to allow the user to identify one or more cards for which the card information is to be accessed and/or retrieved. Here, according to the exemplary embodiment shown in FIG. 2, an upper panel 208 of the float window 207 may be configured to display a list of the one or more cards available to the user as the available stored payment options, e.g.: C1 credit card, C1 debt card, Virtual card A, and so on. Upon the user's selection of an item from the list, the card information stored in association with the payment option is automatically transferred from storage or an executable associated with the settings tile (e.g., via import) into the app that is still concurrently running in the foreground. In some embodiments, the float window may be provided with GUI elements and/or functionality for the user to enter and/or import additional payment options (e.g., card, etc.). In further embodiments, for each payment options provided, the upper panel 208 may also be configured with a GUI element that allows the user to select a “display card #/Info” option to display the details of the payment option via the float window, e.g., before initiating the transfer of the card information via the float window 207 and settings tile 203.

In some embodiments, such as the example shown in FIG. 2, the float window 207 may further include a panel or region (shown, here, as lower panel 210) which may include a virtual keyboard and/or other data-entry and/or data-importation functionality. Such panel or region may be shown as part of other features and functionality, e.g., as shown in FIG. 2, and/or it may be displayed as a separate or distinct GUI element.

According to implementations herein, the system-level settings may be displayed as a float window 207 that may include display of a GUI element (e.g., within a lower window 210, or otherwise) that is configured to generate a virtual keyboard, wherein selection of the GUI element displays, on the screen of the computing device, a virtual keyboard to the user, the virtual keyboard enabling population of a text entry field, by the user using the virtual keyboard. In some embodiments, the text entry field may be configured to receive one or more of login information, authentication information, payment information, card, information, and/or other information, such as information entered via the virtual keyboard otherwise. In other embodiments (not shown in FIG. 2), the system settings may simply cause display, on the screen of the computing device, of just a virtual keyboard to the user, i.e., it may be displayed by itself, or in ways other than via the lower window 210 shown in FIG. 2. Here, again, an illustrative virtual keyboard may enable population of data into an information entry field, wherein, e.g., such information entry field may be configured to receive one or more of login information, authentication information, payment information, card, information, and/or other information.

Referring again to the exemplary embodiment of FIG. 2, a virtual keyboard (shown here within a lower panel 210) may be displayed within or via a new float window upon a user selection indicating that the user desires to enter or import information, such as transaction card information, login and password (e.g., to directly link an account), or the like. As shown in FIG. 2, for example, the user may select the item “generate virtual #”, e.g., in the upper panel 208, to indicate that information of a new card or payment token is entered via the settings tile 203. Here, such virtual keyboard may be configured to acquire the card information by receiving key inputs from the user to capture and store the information about new cards and/or new tokens, at the mobile device, via the settings tile 203. In other examples, upon a user action to add new cards/tokens, the float window may also be configured: (i) to receive, from another device or computer, information regarding a new card for use by the user; (ii) to import such information, such as via a user login and password provided to enable such importation, and/or (iii) to otherwise obtain and integrate such card or payment information into the settings tile 203.

In some embodiments, the settings tile 203 may be configured with a virtual keyboard downloaded from a computer system that is external to the mobile device. In other embodiments, upon the user selecting the settings tile 203, a virtual keyboard may be (exclusively or primarily) displayed to facilitate the user to transfer the card information to the foreground app. According to some implementations, the virtual keyboard may be configured to retrieve the card information automatically upon selection of a graphical user interface element that is displayed on the virtual keyboard and programmed to retrieve or provide the card information for a selected card. In some instances, the virtual keyboard or other such GUI functionality may be configured to automatically inject, via operation of such data entry panel, one or more GUI elements of the foreground app with the card information selected by the user.

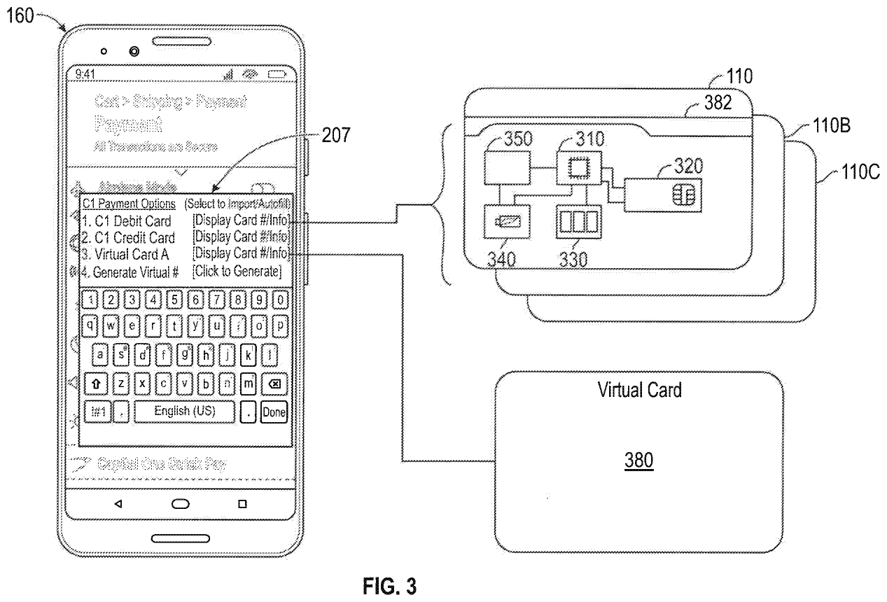

FIG. 3 is a diagram illustrating an example of importing representative transaction card or similar information into a settings tile 207 of a mobile device 160, consistent with exemplary aspects of certain embodiments of the present disclosure. As explained in connection with FIG. 2, above, the settings tile 207 may be generated with transaction card information associated with a variety of transactions cards, virtual cards, and/or other financial/payment accounts of a user. Referring to FIG. 3, the settings tile 207 may contain card information for a plurality of transaction cards 110, 110B, 110C, etc., as well as one or more virtual cards 380, as well as any number of other financial accounts or payment tools associated with a user (not shown), such as banking, saving, checking, etc. accounts, payment-facilitating accounts such as PayPal™, etc., and the like.

Referring to the example embodiment of FIG. 3, transaction cards 110 imported and utilized in connection with the disclosed technology may have embedded electronics for performing various aspects of the disclosed innovations, such as pairing or otherwise communicating with the mobile device 160. As shown by way of illustration and not limitation in FIG. 3, for example, transaction card 110 may include at least one processor 310 or processing circuitry, memory 330, power source or power circuitry 340, communication circuitry/devices 350, a magnetic stripe 382, and other coupling circuitry 320 such as an electronic chip element and associated interconnects. Power source or power circuitry 340 may include elements that generate power for the card, whether via onboard voltage supply such as a battery or external supply, for communicating or pairing with the mobile device 160. In some embodiments, transaction card 110 may include more or fewer components than shown in FIG. 3.

Processor 310 may comprise one or more known or specialized processing devices, of sufficient size and form factor to fit within transaction card 110, e.g., when the transaction card 110 is configured to be about the size of a traditional credit or debit card. In some embodiments, processor 310 may include any configuration capable of performing functions related to the technology and aspects described in connection with the transaction cards herein. Processor 310 may also control power source 340, send and receive data, read data from and write data to memory 330, share and process data with the communication circuitry/devices 350, process information or instructions associated with the coupling circuitry 320, and any other functions consistent with the disclosed technology.

Power source 340 may include a power storage device such as a battery or capacitor, a power receiver such as an inductive power coil or a wireless power receiver, a power generator such as a solar or kinetic power generator, or any combination thereof. In some embodiments, power source 340 may include one or more other known devices capable of generating, receiving, and/or storing electrical energy.

Memory 330 may include volatile or non-volatile, magnetic, semiconductor, or other type of storage elements and/or tangible (i.e., non-transitory) computer-readable medium that stores relevant instructions and data, such as information needed for or associated with authorizing use of the card, conducting card transactions, pairing, and/or other operation/control functionality set forth herein. In some embodiments, the memory 330 may be utilized to store activation and/or control information associated with the transaction card 110, such that the transaction card 110 may, itself, be operable (such as when pairing or communication is attempted) to communicate data related to whether or not the card is activated, whether or not an attempted transaction is approved or disallowed, whether or not other criteria such as geolocation (e.g., determined via handshake with a POS device, etc.) are satisfactory to proceed with a transaction. Such information may be communicated via operation performed via the communication circuitry/devices 350 and/or the other coupling circuitry 320.

According to embodiments herein, transaction card 110 may include communication circuitry/devices 350 including antennae and/or NFC (near-field communication) circuitry, for transmitting and/or receiving data from one or more external locations and devices. Communication circuitry 350 may comprise a short-range wireless transceiver, near-field communication (NFC) chips and components, and the like. Communication circuitry 350 may be configured to communicate with mobile device 160, other systems, and/or other sensors or devices configured to interact with the transaction card 110. In some embodiments, communication circuitry/devices 350 may comprise Bluetooth circuitry for processing Bluetooth communications. In another example, communication circuitry/devices 350 may comprise RF communication circuitry, such as RFID circuitry.

FIG. 4 is a flowchart illustrating one exemplary process 400 related to providing access to and use of transaction card information via system level settings of a mobile device, consistent with exemplary aspects of certain embodiments of the present disclosure. Referring to FIG. 4, an illustrative process 400 related to provision of transaction card information via a settings tile of a mobile device may comprise: enabling a user to access one or more system-level graphical user interface elements within a system-level settings tile of the computing device from a foreground app, wherein the one or more graphical user interface elements are operable to retrieve card information pertaining to one or more cards of the user, at 402; receiving, from the user, a request to access the system-level settings tile while the foreground app is visible on a screen of the computing device, at 404; providing the system-level settings tile comprising the one or more system-level graphical user interface elements to allow the user to identify the one or more cards of the user for which the card information is to be retrieved, at 406; receiving, from the user, a selection of one or more of the system-level graphical user interface elements identifying a desired card from the one or more cards, at 408; in response to the selection from the user, retrieving or copying the card information pertaining to the desired card, at 410; generating, by the computing device, one or more app-level graphical user interface elements of the foreground app with the card information to enable an execution of an activity using the desired card within the foreground app, at 412. Further, such illustrative process 400 may be carried out, in whole or in part, via or in conjunction with the mobile device 160, associated GUIs, and transaction cards 110 described above in connection with FIGS. 2-3.

According to the exemplary embodiment shown in FIG. 4, illustrative process 400 may include, at 402, a step of enabling a user to access one or more system-level graphical user interface elements within a system-level settings tile of the computing device from a foreground app, such one or more graphical user interface elements may be operable to retrieve card information pertaining to one or more cards of the user. In certain instances, step 402 may be performed by a computing device (e.g., user mobile device 160, etc.). With regard to the disclosed innovations, the system-level settings tile may comprise a plurality of tiles, and the graphical user interface element may be configured as a tile of the plurality of tiles. In some embodiments, the system-level settings tile may further comprise a list of the one or more cards available to the user, and at least one graphical user interface feature enabling the user to select the desired card from the list. In other embodiments, the system-level settings tile may include a dynamically-displayed virtual keyboard, or it may be configured as a virtual keyboard or other data entry mechanism, such as by speech, capture of card information via camera, or any other data importation means. Various implementations herein may be configured such that the virtual keyboard is configured to retrieve the card information automatically upon selection of a graphical user interface element that is displayed on the virtual keyboard and programmed to retrieve or provide the card information for a selected card. In other embodiments, the system-level settings tile 203 may be configured with a virtual keyboard downloaded from a computer system that is external to the mobile device.

According to various aspects of the disclosed technology, the card information pertaining to the desired card may also include and/or involve a payment token based on the desired card. In some embodiments, the payment transacted via the app may be a token-based payment transaction. Here, for example, the payment token may comprise information corresponding to one or more of: a card number, a card verification value (CVV), or other security, code, a card expiration date, an address, a card holder name, an indicator of whether the payment token is for a single use or multiple use, an indicator of a number of use of the payment token, an expiration time of the payment token, a spending limit of the payment token, an exclusion list of the payment token, an inclusive list of the payment token, and a geo-limit of the payment token.

With regard to the graphical user interface element of the system-level settings tile 203, various implementations may be configured such that the graphical user interface element of the system-level settings tile is configured to acquire the card information by providing input fields into which the user enters the card information of the one or more cards. Such graphical user interface element of the system-level settings tile may further be configured to receive, e.g., via communication with another device, computer or transaction card, information regarding a new card for use by the user.

In some embodiments, illustrative process 400 may include a step of receiving from the user, a request to access the system-level settings tile while the foreground app is visible on a screen of the computing device, at 404; a step of providing the system-level settings tile comprising the one or more system-level graphical user interface elements to allow the user to identify the one or more cards of the user for which the card information is to be retrieved, at 406; a step of receiving, from the user, a selection of one or more of the system-level graphical user interface elements identifying a desired card from the one or more cards; at 408; a step of, in response to the selection from the user, retrieving or copying the card information pertaining to the desired card at 410; and a step of generating one or more app-level graphical user interface elements of the foreground app with the card information to enable an execution of an activity using the desired card within the foreground app, at 412. In various implementations, one or more of steps 404, 406, 408, and/or 410 may be performed by the mobile device 160. In some embodiments, the retrieving or copying the card information may comprise copying and pasting via a clipboard that stores the card information. In some examples, the activity executed via the foreground app may comprise a purchase transaction. In some embodiments, step 412 may comprise automatically injecting, via operation of the virtual keyboard of the mobile device, to generate the app-level graphical user interface elements of the foreground app with the card information to enable an execution of an activity using the desired card within the foreground app.

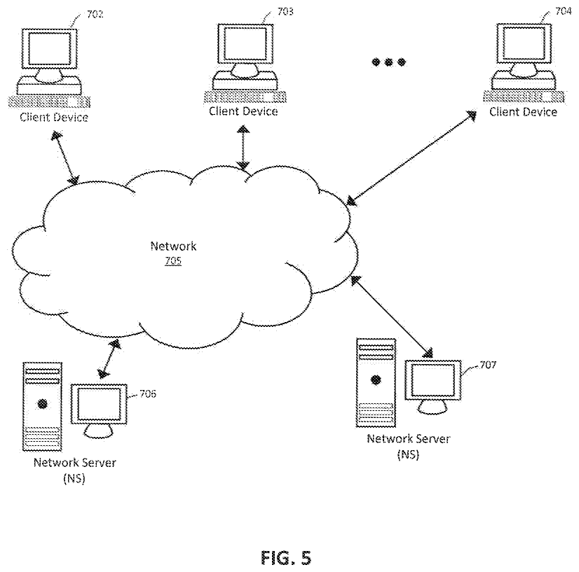

FIG. 5 depicts a block diagram of an exemplary computer-based system/platform in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform may be configured to manage a large number of instances of software applications, users, and/or concurrent transactions, as detailed herein. In some embodiments, the exemplary computer-based system/platform may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 5, members 702-704 (e.g., POS devices or clients) of the exemplary computer-based system/platform may include virtually any computing device capable of receiving and sending a message over a network (e.g., cloud network), such as network 705, to and from another computing device, such as servers 706 and 707, each other, and the like. In some embodiments, the member devices 702-704 may be personal computers, multiprocessor systems, microprocessor-based or programmable consumer electronics, network PCs, and the like. In some embodiments, one or more member devices within member devices 702-704 may include computing devices that typically connect using wireless communications media such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 702-704 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 702-704 may include may run one or more applications, such as Internet browsers, mobile applications, voice calls, video games, videoconferencing, and email, among others. In some embodiments, one or more member devices within member devices 702-704 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 702-704 may be specifically programmed by either Java, .Net, QT, C, C++ and/or other suitable programming language. In some embodiments, one or more member devices within member devices 702-704 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 705 may provide network access, data transport and/or other services to any computing device coupled to it. In some embodiments, the exemplary network 705 may include and implement at least one specialized network architecture that may be based at least in part on one or more standards set by, for example, without limitation, GlobalSystem for Mobile communication (GSM) Association, the Internet Engineering Task Force (IETF), and the Worldwide Interoperability for Microwave Access (WiMAX) forum. In some embodiments, the exemplary network 705 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 705 may include and implement, as an alternative or in conjunction with one or more of the above, a WiMAX architecture defined by the WiMAX forum. In some embodiments and, optionally, in combination of any embodiment described above or below, the exemplary network 705 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 705 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 705 may also include mass storage, such as network attached storage (NAS), a storage area network (SAN), a content delivery network (CDN) or other forms of computer- or machine-readable media.

In some embodiments, the exemplary server 706 or the exemplary server 707 may be a web server (or a series of servers) running a network operating system, examples of which may include but are not limited to Microsoft Windows Server, Novell NetWare, or Linux. In some embodiments, the exemplary server 706 or the exemplary server 707 may be used for and/or provide cloud and/or network computing. Although not shown in FIG. 5, in some embodiments, the exemplary server 706 or the exemplary server 707 may have connections to external systems like email, SMS messaging, text messaging, ad content providers, etc. Any of the features of the exemplary server 706 may be also implemented in the exemplary server 707 and vice versa.

In some embodiments, one or more of the exemplary servers 706 and 707 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 701-704.

In some embodiments and, optionally, in combination of any embodiment described above or below, for example, one or more exemplary computing member devices 702-704, the exemplary server 706, and/or the exemplary server 707 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof

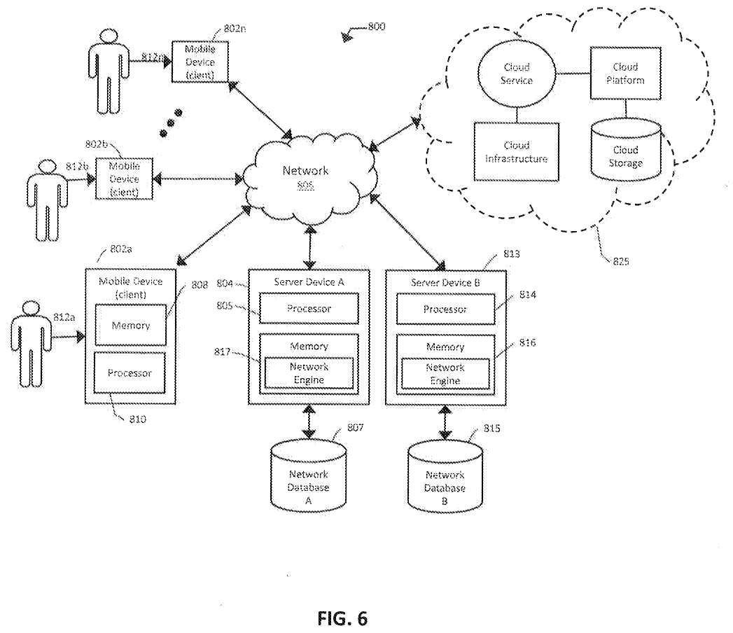

FIG. 6 depicts a block diagram of another exemplary computer-based system/platform 800 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices (e.g., POS devices) 802a, 802b through 802n shown each at least includes computer-readable media, such as a random-access memory (RAM) 808 coupled to a processor 810 and/or memory 808. In some embodiments, the processor 810 may execute computer-executable program instructions stored in memory 808. In some embodiments, the processor 810 may include a microprocessor, an ASIC, and/or a state machine. In some embodiments, the processor 810 may include, or may be in communication with, media, for example computer-readable media, which stores instructions that, when executed by the processor 810, may cause the processor 810 to perform one or more steps described herein. In some embodiments, examples of computer-readable media may include, but are not limited to, an electronic, optical, magnetic, or other storage or transmission device capable of providing a processor, such as the processor 810 of client 802a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 802a through 802n may also comprise a number of external or internal devices such as a mouse, a CD-ROM, DVD, a physical or virtual keyboard, a display, a speaker, or other input or output devices. In some embodiments, examples of member computing devices 802a through 802n (e.g., clients) may be any type of processor-based platforms that are connected to a network 806 such as, without limitation, personal computers, digital assistants, personal digital assistants, smart phones, pagers, digital tablets, laptop computers, Internet appliances, and other processor-based devices. In some embodiments, member computing devices 802a through 802n may be specifically programmed with one or more application programs in accordance with one or more principles/methodologies detailed herein. In some embodiments, member computing devices 802a through 802n may operate on any operating system capable of supporting a browser or browser-enabled application, such as Microsoft™ Windows™, and/or Linux. In some embodiments, member computing devices 802a through 802n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 802a through 802n, users, 812a through 812n, may communicate over the exemplary network 806 with each other and/or with other systems and/or devices coupled to the network 806. As shown in FIG. 6, exemplary server devices 804 and 813 may be also coupled to the network 806. In some embodiments, one or more member computing devices 802a through 802n may be mobile clients.

In some embodiments, at least one database of exemplary databases 807 and 815 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

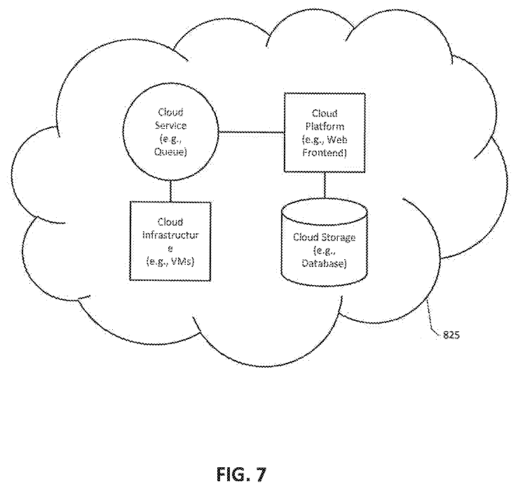

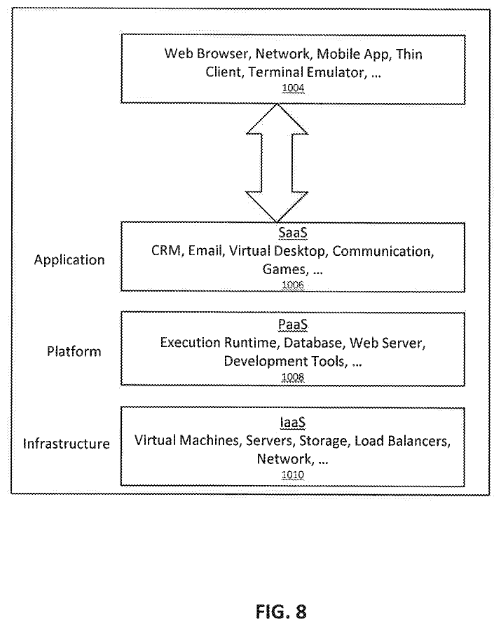

As also shown in FIGS. 7 and 8, some embodiments of the disclosed technology may also include and/or involve one or more cloud components 825, which are shown grouped together in the drawing for sake of illustration, though may be distributed in various ways as known in the art. Cloud components 825 may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.).

According to some embodiments shown by way of one example in FIG. 8, the exemplary inventive computer-based systems/platforms, the exemplary inventive computer-based devices, components and media, and/or the exemplary inventive computer-implemented methods of the present disclosure may be specifically configured to operate in or with cloud computing/architecture such as, but not limiting to: infrastructure a service (IaaS) 1010, platform as a service (PaaS) 1008, and/or software as a service (SaaS) 1006. FIGS. 7 and 8 illustrate schematics of exemplary implementations of the cloud computing/architecture(s) in which the exemplary inventive computer-based systems/platforms, the exemplary inventive computer-implemented methods, and/or the exemplary inventive computer-based devices, components and/or media of the present disclosure may be specifically configured to operate. In some embodiments, such cloud architecture 1006, 1008, 1010 may be utilized in connection with the Web browser and browser extension aspects, shown at 1004, to achieve the innovations herein.

As used in the description and in any claims, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems/platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), Bluetooth™, near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. Various embodiments herein may include interactive posters that involve wireless, e.g., Bluetooth™ and/or NFC, communication aspects, as set forth in more detail further below. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) are within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components (e.g., FIG. 7-8) and cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a tweet, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) AmigaOS, AmigaOS 4; (2) FreeBSD, NetBSD, OpenBSD; (3) Linux; (4) Microsoft Windows; (5) OpenVMS; (6) OS X (Mac OS); (7) OS/2; (8) Solaris; (9) Tru64 UNIX; (10) VM; (11) Android; (12) Bada; (13) BlackBerry OS; (14) Firefox OS; (15) Ios; (16) Embedded Linux; (17) Palm OS; (18) Symbian; (19) Tizen; (20) WebOS; (21) Windows Mobile; (22) Windows Phone; (23) Adobe AIR; (24) Adobe Flash; (25) Adobe Shockwave; (26) Binary Runtime Environment for Wireless (BREW); (27) Cocoa (API); (28) Cocoa Touch; (29) Java Platforms; (30) JavaFX; (31) JavaFX Mobile; (32) Microsoft XNA; (33) Mono; (34) Mozilla Prism, XUL and XULRunner; (35) .NET Framework; (36) Silverlight; (37) Open Web Platform; (38) Oracle Database; (39) Qt; (40) SAP NetWeaver; (41) Smartface; (42) Vexi; and (43) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like.

In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry ^{TM}, Pager, Smartphone, smart watch, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

The aforementioned examples are, of course, illustrative and not restrictive.

As used herein, the term “user” shall have a meaning of at least one user. In some embodiments, the terms “user”, “subscriber”, “consumer”, or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

At least some aspects of the present disclosure will now be described with reference to the following numbered clauses.
Clause 1. A method comprising:
   enabling, by a computing device, a user to access one or more system-level graphical user interface elements within a system-level settings tile of the computing device from a foreground app, wherein the one or more graphical user interface elements are operable to retrieve card information pertaining to one or more cards of the user;
   receiving, by the computer device, from the user, a request to access the system-level settings tile while the foreground app is visible on a screen of the computing device;
   providing, by the computing device, the system-level settings tile comprising the one or more system-level graphical user interface elements to allow the user to identify the one or more cards of the user for which the card information is to be retrieved;
   receiving, by the computing device, from the user, a selection of one or more of the system-level graphical user interface elements identifying a desired card from the one or more cards;
   in response to the selection from the user, retrieving or copying, by the computing device, the card information pertaining to the desired card; and
   generating, by the computing device, one or more app-level graphical user interface elements of the foreground app with the card information to enable an execution of an activity using the desired card within the foreground app.
Clause 2. The method of clause 1 or the innovation(s) according to other aspects herein, wherein the system-level settings tile comprises a plurality of tiles, and the graphical user interface element is configured as a tile of the plurality of tiles.
Clause 3. The method of clause 1 or the innovation(s) according to other aspects herein, wherein the system-level settings tile further comprises a list of the one or more cards available to the user, and at least one graphical user interface feature enabling the user to select the desired card from the list.
Clause 4. The method of clause 1 or the innovation(s) according to other aspects herein, wherein the system-level settings include one or both of:
   display of a keyboard tile, selection of which yields displays, on the screen of the computing device, a virtual keyboard to the user, the virtual keyboard enabling population, by the user and/or otherwise, of a text entry field, wherein the text entry field is configured to receive one or more of login information, card or payment information, authentication information, and/or other information; and/or
   a dynamically displayed virtual keyboard.
Clause 5. The method of clause 4 or the innovation(s) according to other aspects herein, wherein the virtual keyboard is configured to retrieve the card information automatically upon selection of a graphical user interface element that is displayed on the virtual keyboard and programmed to retrieve or provide the card information for a selected card.
Clause 6. The method of clause 1 or the innovation(s) according to other aspects herein, one or both of:
   wherein selection of the system settings comprises display, on the screen of the computing device, of a virtual keyboard to the user, the virtual keyboard enabling population, by the user, of a text entry field, wherein the text entry field is configured to receive one or more of login information, card or payment information, authentication information, and/or other information; and/or
   wherein the system settings tile is configured as a virtual keyboard.
Clause 7. The method of clause 1 or the innovation(s) according to other aspects herein, wherein the card information pertaining to the desired card comprises a payment token based on the desired card, and the payment transacted via the app is a token-based payment transaction.
Clause 8. The method of clause 7 or the innovation(s) according to other aspects herein, wherein the payment token comprises information corresponding to one or more of: a card number, a card verification value (CVV), or other security, code, a card expiration date, an address, a card holder name, an indicator of whether the payment token is for a single use or multiple use, an indicator of a number of use of the payment token, an expiration time of the payment token, a spending limit of the payment token, an exclusion list of the payment token, an inclusive list of the payment token, and a geo-limit of the payment token.
Clause 9. The method of clause 1 or the innovation(s) according to other aspects herein, wherein the transferring of the card information of the desired card comprises copying and pasting via a clipboard that stores the card information.
Clause 10. The method of clause 1 or the innovation(s) according to other aspects herein, wherein the graphical user interface element of the system-level settings tile is configured to acquire the card information by providing input fields into which the user enters the card information of the one or more cards.
Clause 11. The method of clause 1 or the innovation(s) according to other aspects herein, wherein the graphical user interface element of the system-level settings tile is configured by receiving, from another device or computer, information regarding a new card for use by the user.
Clause 12. The method of clause 1 or the innovation(s) according to other aspects herein, wherein the activity comprises a purchase transaction.
Clause 13. A method comprising:
   enabling, by a computing device, a user to access one or more system-level graphical user interface elements within a system-level settings tile of the computing device from a foreground app,
   wherein the system-level settings tile is configured with a virtual keyboard downloaded from a computer system that is external to the computing device, and
   wherein the one or more graphical user interface elements are operable to retrieve card information pertaining to one or more cards of the user;
   receiving, by the computer device, from the user, a request to access the system-level settings tile while the foreground app visible on a screen of the computing device;
   providing, by the computing device, the system-level settings tile comprising the one or more system-level graphical user interface elements to allow the user to identify the one or more cards of the user for which the card information to be retrieved;
   receiving, by the computing device, from the user, a selection of one or more of the system-level graphical user interface elements identifying a desired card from the one or more cards;
   in response to the selection from the user, retrieving or copying, by the computing device, the card information pertaining to the desired card; and
   automatically injecting, via operation of the virtual keyboard of the computing device, one or more app-level graphical user interface elements of the foreground app with the card information to enable an execution of an activity using the desired card within the foreground app.
Clause 14. The method of clause 13 or the innovation(s) according to other aspects herein, wherein the system-level settings tile comprises a plurality of tiles, and the graphical user interface element is configured as a tile of the plurality of tiles.
Clause 15. The method of clause 13 or the innovation(s) according to other aspects herein, wherein the system-level settings tile further comprises a list of the one or more cards available to the user, and at least one graphical user interface feature enabling the user to select the desired card from the list.
Clause 16. The method of clause 13 or the innovation(s) according to other aspects herein, wherein the virtual keyboard is configured to retrieve the card information automatically upon selection of a graphical user interface element that is displayed on the virtual keyboard and programmed to retrieve or provide the card information for a selected card.
Clause 17. The method of clause 13 or the innovation(s) according to other aspects herein, wherein the card information pertaining to the desired card comprises a payment token based on the desired card, and the payment transacted via the app is a token-based payment transaction.
Clause 18. The method of clause 17 or the innovation(s) according to other aspects herein, wherein the payment token comprises information corresponding to one or more of: a card number, a card verification value (CVV), or other, security code, a card expiration date, an address, a card holder name, an indicator of whether the payment token is for a single use or multiple use, an indicator of a number of use of the payment token, an expiration time of the payment token, a spending limit of the payment token, an exclusion list of the payment token, an inclusive list of the payment token, and a geo-limit of the payment token.
Clause 19. The method of clause 13 or the innovation(s) according to other aspects herein, wherein the transferring of the card information of the desired card comprises copying and pasting via a clipboard that stores the card information.
Clause 20. The method of clause 13 or the innovation(s) according to other aspects herein, wherein the graphical user interface element of the system-level settings tile is configured to acquire the card information by providing input fields into which the user enters the card information of the one or more cards.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A method comprising:
enabling, by a computing device, a user to access one or more system-level graphical user interface elements within a system-level settings tile of the computing device from a foreground application, wherein the one or more graphical user interface elements are operable to obtain card information pertaining to one or more cards of the user;
receiving, by the computer device, from the user, an input to access the system-level settings tile while the foreground application is visible on a screen of the computing device;
providing, by the computing device, the system-level settings tile comprising the one or more system-level graphical user interface elements to allow the user to identify the one or more cards of the user for which the card information is to be obtained;
receiving, by the computing device, from the user, a selection of one or more of the system-level graphical user interface elements identifying a desired card from the one or more cards;
in response to the selection from the user, retrieving or copying, by the computing device, the card information pertaining to the desired card; and
generating, by the computing device, one or more application-level graphical user interface elements of the foreground application with the card information to enable an execution of an activity using the desired card within the foreground application.

2. The method of claim 1, wherein the system-level settings tile comprises a plurality of tiles, and the graphical user interface element is configured as a tile of the plurality of tiles.

3. The method of claim 1, wherein the system-level settings tile further comprises a list of the one or more cards available to the user, and at least one graphical user interface feature enabling the user to select the desired card from the list.

4. The method of claim 1, wherein the system-level settings include display of a GUI element configured to generate a virtual keyboard, wherein selection of the GUI element displays, on the screen of the computing device, a virtual keyboard to the user, the virtual keyboard enabling population of a text entry field, by the user using the virtual keyboard, wherein the text entry field is configured to receive one or more of login information, authentication information, payment information, card, information, and/or other information.

5. The method of claim 4 wherein the virtual keyboard is configured to obtain the card information automatically upon selection of a graphical user interface element that is displayed on the virtual keyboard and programmed to obtain or provide the card information for a selected card.

6. The method of claim 1 wherein selection of the system settings causes display, on the screen of the computing device, of a virtual keyboard to the user, the virtual keyboard enabling population of an information entry field, wherein the information entry field is configured to receive one or more of login information, authentication information, payment information, card, information, and/or other information.

7. The method of claim 1, wherein the card information pertaining to the desired card comprises a payment token based on the desired card, and the payment transacted via the application is a token-based payment transaction.

8. The method of claim 7, wherein the payment token comprises information corresponding to one or more of: a card number, a card verification value (CVV), or other security, code, a card expiration date, an address, a card holder name, an indicator of whether the payment token is for a single use or multiple use, an indicator of a number of use of the payment token, an expiration time of the payment token, a spending limit of the payment token, an exclusion list of the payment token, an inclusive list of the payment token, and a geo-limit of the payment token.

9. The method of claim 1, wherein the retrieving or copying the card information pertaining to the desired card comprises copying and pasting via a clipboard that stores the card information.

10. The method of claim 1, wherein the graphical user interface element of the system-level settings tile is configured to acquire the card information by providing input fields into which the user enters the card information of the one or more cards.

11. The method of claim 1, wherein the graphical user interface element of the system-level settings tile is configured by receiving, from another device or computer, information regarding a new card for use by the user.

12. The method of claim 1 wherein the activity comprises a purchase transaction.

13. A method comprising:
enabling, by a computing device, a user to access one or more system-level graphical user interface elements within a system-level settings tile of the computing device from a foreground application (app),
wherein the system-level settings tile is configured with a virtual keyboard downloaded from a computer system that is external to the computing device, and
wherein the one or more graphical user interface elements are operable to obtain card information pertaining to one or more cards of the user;
receiving, by the computer device, from the user, an input to access the system-level settings tile while the foreground application visible on a screen of the computing device;
providing, by the computing device, the system-level settings tile comprising the one or more system-level graphical user interface elements to allow the user to identify the one or more cards of the user for which the card information to be obtained;
receiving, by the computing device, from the user, a selection of one or more of the system-level graphical user interface elements identifying a desired card from the one or more cards;
in response to the selection from the user, retrieving or copying, by the computing device, the card information pertaining to the desired card; and
automatically injecting, via operation of the virtual keyboard of the computing device, one or more application-level graphical user interface elements of the foreground application with the card information to enable an execution of an activity using the desired card within the foreground application.

14. The method of claim 13, wherein the system-level settings tile comprises a plurality of tiles, and the graphical user interface element is configured as a tile of the plurality of tiles.

15. The method of claim 13, wherein the system-level settings tile further comprises a list of the one or more cards available to the user, and at least one graphical user interface feature enabling the user to select the desired card from the list.

16. The method of claim 13, wherein the virtual keyboard is configured to obtain the card information automatically upon selection of a graphical user interface element that is displayed on the virtual keyboard and programmed to obtain or provide the card information for a selected card.

17. The method of claim 13, wherein the card information pertaining to the desired card comprises a payment token based on the desired card, and the payment transacted via the application is a token-based payment transaction.

18. The method of claim 17, wherein the payment token comprises information corresponding to one or more of: a card number, a card verification value (CVV), or other, security code, a card expiration date, an address, a card holder name, an indicator of whether the payment token is for a single use or multiple use, an indicator of a number of use of the payment token, an expiration time of the payment token, a spending limit of the payment token, an exclusion list of the payment token, an inclusive list of the payment token, and a geo-limit of the payment token.

19. The method of claim 13, wherein the retrieving or copying the card information pertaining to the desired card comprises copying and pasting via a clipboard that stores the card information.

20. The method of claim 13, wherein the graphical user interface element of the system-level settings tile is configured to acquire the card information by providing input fields into which the user enters the card information of the one or more cards.
